(19) United States
(12) Patent Application Publication
(10) Pub. No.: US 2023/0265321 A1
(43) Pub. Date: Aug. 24, 2023

(54) HOT-APPLIED ASPHALTIC AND NON-ASPHALTIC SEALANT COMPOSITIONS AND METHODS

(71) Applicant: Adventus Material Strategies, LLC, Daniel Island, SC (US)

(72) Inventors: Joseph Drbohlav, III, Inman, SC (US); Brian J. Majeska, Daniel Island, SC (US); Christopher Shane Kinder, Foster, OK (US); Joseph J. Lorenc, Philadelphia, PA (US)

(21) Appl. No.: 17/677,019

(22) Filed: Feb. 22, 2022

(51) Int. Cl. C09J 153/02; C09J 11/08

(52) U.S. Cl. CPC C09J 153/02; C09J 11/08

(57) ABSTRACT

Hot-applied asphaltic and non-asphaltic sealant compositions and methods having or using defined effective polymer concentration (EPC) values of at least 7.0 are provided which (a) provide improved softening points and improved resilience without the use of any inorganic filler materials, while at the same time maintaining or increasing the ductilities of the compositions, or (b) enable the use of one or more inorganic filler materials to provide improved softening points and improved resilience while maintaining desirable viscosity levels and at least significantly limiting any losses in ductility or increasing the ductilities of the compositions.

### FIELD OF THE INVENTION

The present invention relates to hot-applied asphaltic and non-asphaltic sealant compositions, methods of production, and methods of use for sealing cracks and joints in roads, pavements, or other asphalt or concrete substrates.

### BACKGROUND OF THE INVENTION

Hot-applied crack and joint sealants must meet several performance parameters in order to be effective for waterproofing cracks and joints in asphalt and concrete pavements. One such parameter is the ring and ball softening point of the hot-applied sealant material. A minimum ring and ball softening point is needed to ensure that the sealant will not flow at high in-service temperatures. Typically, a minimum softening point for most applications is 80° C., with a 90° C. minimum being more preferred and a 100° C. minimum softening point being most preferred.

Another important performance parameter is the viscosity of the hot-applied sealant material. The sealant material must have a viscosity that allows it to flow into cracks and coat the substrate at reasonable application temperatures, typically in the range of from 350° F. to 400° F. A rotational viscosity of less than 4000 eps at 350° F. is preferred, with a rotational viscosity of less than 3500 cps at 350° F. being more preferred and a viscosity of less than 3000 cps at 350° F. being most preferred.

Another important performance parameter is the “resilience” of the sealant material as determined in accordance with ASTM D5329. The ASTM D5329 resilience test for hot-applied crack and joint sealant compositions measures the ability of the sealant composition to resist a solid, hard object (e.g., a rock) which is pressed into the surface of the applied material. The resilience of a sealant material is analogous to the elastic recovery of an asphalt binder. i.e., the ability of the asphalt to recover its shape quickly after being deformed. It is preferred that a hot-applied crack and joint sealant have a resilience of at least 50% when measured according to ASTM D5329. More preferably, the resilience of the sealant material will be at least 60% and will most preferably be 70% or greater.

Yet another important performance parameter is the “ductility” of the hot-applied sealant material. A hot-applied crack and joint sealant must demonstrate the ability to undergo stretching or elongation without breaking. This tensile property of a sealant, referred to as “ductility”, is more severe when measured at colder temperatures. To ensure adequate tensile strength and flexibility at low temperatures, a hot-applied crack and joint sealant should have a minimum ductility at 4° C. of 20 cm when measured in accordance with ASTM D113. More preferably, the sealant will have a minimum ductility at 4° C. of 30 cm and will most preferably have a minimum ductility of 40 cm when measured at a temperature of 4° C.

Hot-applied asphaltic crack and joint sealants are formulated with a base resin comprising asphalt. It is often beneficial to include a plasticizing or diluent oil with the asphalt base material in order to improve the low temperature flexibility of the composition. However, this is not always required, depending on the source and characteristics of the asphalt used. In addition, hot-applied crack and joint sealants typically include elastomeric or other polymeric modifiers which improve the thermal and tensile properties of the sealant. An example of one commonly used polymer is a styrene-butadiene block copolymer. Commercially available sealants typically also include mineral or other inorganic fillers which reduce the cost and/or improve one or more of the high temperature performance characteristics of the sealant composition.

For some hot-applied sealant applications, it is beneficial to have a sealant that can be pigmented to a color that matches the substrate to which it is applied. Unfortunately, the pigmented and non-pigmented colors of asphalt-based sealants are generally limited to black or brown. However, hot-applied non-asphaltic sealant compositions, formed from non-asphalt base resin materials, are available which can be pigmented to virtually any color, including even the gray color of Portland cement concrete.

When non-asphalt base resins are used, the targeted performance parameters of the non-asphaltic sealant compositions change due to the thermal and physical properties of the non-asphalt base resins as compared to the properties of asphalt. For example, the rotational viscosity at 350° F. for a hot-applied non-asphaltic sealant composition will typically be in the range of 5500-7000 eps, with viscosities below 5500 cps being more preferred, and viscosities below 5000 cps being most preferred, when measured at 350° F. The softening point of the hot-applied non-asphaltic sealant composition will preferably be at least 80° C. and will more preferably be at least 85° C. Furthermore, it is desirable that these non-asphalt-based sealants have a 4° C. ductility of greater than 30 cm and more preferably greater than 40 cm when measured in accordance with ASTM D113. In addition, the ASTM D5329 resilience values of the non-asphalt-based sealants are preferably at least about 50% and are more preferably at least 60%.

A continuing need exists for asphalt-based sealant compositions and non-asphalt-based sealant compositions having improved softening points, resilience values, and other performance parameters. As noted above, one technique that has been used for improving one or more performance parameters of an asphalt-based or non-asphalt-based sealant composition has been to add one or more inorganic fillers. Unfortunately, however, while often improving one or more performance parameters, the prior use of inorganic fillers has typically detracted significantly from the ductility or other tensile parameters of the sealant composition, and/or has increased the viscosity of sealant composition to an undesirable level.

Consequently, a need particularly exists for hot-applied sealant compositions which will provide improved softening points and improved resilience without the use of any inorganic filler materials, while at the same time maintaining or increasing the ductilities of the compositions and providing suitable viscosities. In addition, a need particularly exists for hot-applied sealant compositions which will enable the use one or more inorganic filler materials to provide improved softening points and improved resilience while maintaining desirable viscosity levels and improving, or at least preventing or significantly limiting any reduction of, the ductility of the composition.

### SUMMARY OF THE INVENTION

The present invention provides hot-applied asphaltic and non-asphaltic sealant compositions and methods which alleviate the problems and satisfy the needs mentioned above. The improved hot-applied sealant compositions and methods include sealant compositions and methods which provide improved softening points and improved resilience without the use of any inorganic filler materials, while at the same time maintaining or increasing the ductilities of the compositions. The improved hot-applied sealant compositions and methods also include sealant compositions and methods which enable the use one or more inorganic filler materials to provide improved softening points and improved resilience while maintaining desirable viscosity levels and improving, or at least preventing or significantly limiting any reduction of, the ductilities of the compositions.

In one aspect, there is provided an asphaltic sealant composition which uses an effective polymer concentration (EPC) to improve a softening point and a resilience of the asphaltic sealant composition while at least reducing or preventing a loss of or providing an increase in ductility. The asphaltic sealant composition preferably comprises: (a) a total percent by weight of asphalt (% Asphalt) which is not less than 50% by weight of a total weight of the asphaltic sealant composition; (b) a total percent by weight of one or more plasticizers (% Plasticizer) which is not less than 2% by weight of the total weight of the asphaltic sealant composition; (c) a total percent by weight of one or more polymers (% Polymer) which is not less than 4% by weight of the total weight of the asphaltic sealant composition; and (d) a crumb rubber modifier in an amount in a range of from 0% to 15% by weight based upon the total weight of the asphaltic sealant composition. The asphaltic sealant composition also has either (i) no inorganic filler material therein or (ii) one or more inorganic fillers therein which is/are limited to only titanium dioxide and/or ferric oxide so that the asphaltic sealant composition excludes any inorganic filler other than titanium dioxide and/or ferric oxide. Moreover, the EPC of the asphalt sealant composition, defined as:

EPC (% Polymer+(% Polymer+% Asphalt+% Plasticizer))×100,

is preferably not less than 7.0.

As the previous paragraph indicates, and as defined and used herein and in the claims, the % Polymer, % Asphalt, and % Plasticizer values used in the formula for determining the EPC value of the inventive asphaltic sealant composition are the respective individual percent by weight fractions, based upon the total weight of the sealant composition, of only (1) the total weight of the polymer component(s), (2) the total weight of the asphalt component(s), and (3) the total weight of the plasticizer component(s) used in the sealant formulation. In addition to these components, the asphaltic sealant composition may also include further ingredients (e.g., an inorganic filler and/or crumb rubber) so that the weight fractions of all of the components of the asphaltic sealant composition, including any and all further ingredients, will total 100%. Consequently, where the inventive asphaltic sealant composition includes one or more ingredients in addition to the polymer, asphalt, and plasticizer components, the value of the sum of the weight percentages “(% Polymer+% Asphalt+% Plasticizer)” used in the formula stated above for determining the EPC value of the inventive asphaltic sealant composition will total less than 100%.

In another aspect, there is provided an asphaltic sealant composition as described above which preferably further comprises a ratio of the total percent by weight of the one or more plasticizers (% Plasticizer) to the total percent by weight of the one or more polymers (% Polymer) being in a range of from 0.4:1 to 0.6:1.

In another aspect, there is provided an asphaltic sealant composition as described above wherein each of the one or more polymers is selected from the group consisting of radial styrene-butadiene-styrene block copolymers, linear styrene-butadiene-styrene block copolymers, styrene butadiene copolymers, styrene isoprene copolymers, styrene isoprene styrene block copolymers, ethylene vinyl acetate, ethylene-propylene-diene monomer rubber, polyethylene, polypropylene, terpolymers of ethylene and butyl acrylate comonomer, other acrylic copolymers, and other acrylic terpolymers.

In another aspect, there is provided a non-asphaltic sealant composition which uses an effective polymer concentration (EPC) to improve a softening point and a resilience of the non-asphaltic sealant composition while at least reducing or preventing a loss of or providing an increase in ductility. The non-asphaltic sealant composition preferably comprises: (a) a total percent by weight of a non-asphalt sealant resin (% Resin) which is not less than 50% by weight of a total weight of the non-asphaltic sealant composition; (b) a total percent by weight of one or more plasticizers (% Plasticizer) which is not less than 0.5% by weight of the total weight of the non-asphaltic sealant composition; (c) a total percent by weight of one or more polymers (% Polymer) which is not less than 5% by weight of the total weight of the non-asphaltic sealant composition; (d) a crumb rubber modifier in an amount in a range of from 0% to 15% by weight based upon the total weight of the non-asphaltic sealant composition; and (e) one or more inorganic fillers in a total amount of not less than 3% by weight of the total weight of the non-asphaltic sealant composition. Moreover, the EPC of the non-asphaltic sealant composition, defined as:

EPC=(% Polymer+(% Polymer+% Resin+% Plasticizer))×100,

is preferably not less than 11.2.

As the previous paragraph indicates, and as defined and used herein and in the claims, the % Polymer, % Resin, and % Plasticizer values used in the formula for determining the EPC value of the inventive non-asphaltic sealant composition are the respective individual percent by weight fractions, based upon the total weight of the non-asphaltic sealant composition, of only (1) the total weight of the polymer component(s), (2) the total weight of the resin component(s), and (3) the total weight of the plasticizer component(s) used in the sealant formulation. In addition to these components, the non-asphaltic sealant composition may also include further ingredients (e.g., an inorganic filler and/or crumb rubber) so that the individual weight fractions of all of the components of the non-asphaltic sealant composition, including any and all further ingredients, will total 100%. Consequently, where the inventive non-asphaltic sealant composition includes one or more ingredients in addition to the polymer, resin, and plasticizer components, the value of the sum of the weight percentages “(% Polymer+% Resin+% Plasticizer)” used in the formula stated above for determining the EPC value of the inventive non-asphaltic sealant composition will total less than 100%.

In another aspect, there is provided a non-asphaltic sealant composition as described above wherein each of the one or more polymers is selected from the group consisting of radial styrene-butadiene-styrene block copolymers, linear styrene-butadiene-styrene block copolymers, styrene butadiene copolymers, styrene isoprene copolymers, styrene isoprene styrene block copolymers, ethylene vinyl acetate, ethylene-propylene-diene monomer rubber, polyethylene, polypropylene, terpolymers of ethylene and butyl acrylate comonomer, other acrylic copolymers, and other acrylic terpolymers.

Further aspects, features, and advantages of the present invention will be apparent to those in the art upon reading the following detailed description of the preferred embodiments.

### DETAILED DESCRIPTION OF THE PREFERRED EMBODIMENTS

The hot-applied asphaltic sealant composition provided by the present invention preferably comprises: a total percent by weight of a base asphalt material (% Asphalt) which is not less than 50% by weight of the total weight of the asphaltic sealant composition; a total percent by weight of one or more plasticizers (% Plasticizer) which is not less than 2% by weight of the total weight of the asphaltic sealant composition; a total percent by weight of one or more polymers (% Polymer) which is not less than 4% by weight of the total weight of the asphaltic sealant composition; and an optional amount of a crumb rubber modifier in the range of from 0% to 15% by weight based upon the total weight of the asphaltic sealant composition. The inventive asphaltic sealant composition will provide an improved softening point, an improved resilience, a suitable or improved viscosity, and a suitable or improved ductility either (a) without the use of any inorganic filler material in the asphaltic sealant composition or (b) by exclusively limiting the inorganic filler material used in the asphaltic sealant composition to only titanium dioxide and/or ferric oxide.

In order to provide significant improvements in the softening point and resilience of the inventive hot-applied asphaltic sealant composition while also substantially maintaining or improving the ductility of the composition, we have discovered that the asphaltic sealant composition should be formulated to provide an “effective polymer concentration” (EPC) value of not less than 7.0. For a hot-applied asphaltic sealant composition, the EPC parameter which we have discovered is defined as:

EPC=(% Polymer (% Polymer+% Asphalt+% Plasticizer))×100

Each embodiment of the inventive hot-applied asphaltic sealant composition, either with or without the use of a filler material, will more preferably have an EPC value of not less than 7.2, or not less than 7.3, or not less than 7.4, or less than 7.5, or not less than 7.6, or not less than 7.7, or not less than 7.8, or not less than 7.9, or not less than 8.0. For the embodiment of the hot-applied asphaltic sealant composition having no inorganic filler material therein, the EPC value will most preferably be in the range of from about 8.0 to about 9.0 (i.e., from 8.0 minus 5% up to 9.0 plus 5%). For the embodiment of the hot-applied asphaltic sealant composition which includes a titanium dioxide and/or ferric oxide filler material, the EPC value will most preferably be in the range of from about 7.5 to about 8.5 (i.e., from 7.5 minus 5% up to 8.5 plus 5%).

As noted above, and as defined and used herein and in the claims, the % Polymer, % Asphalt, and % Plasticizer values used in the formula for determining the EPC value of the inventive asphaltic sealant composition are the respective individual percent by weight fractions, based upon the total weight of the sealant composition, of only (1) the total weight of the polymer component(s), (2) the total weight of the asphalt component(s), and (3) the total weight of the plasticizer component(s) used in the sealant formulation. In addition to these components, the asphaltic sealant composition may also include further ingredients (e.g., an inorganic filler and/or crumb rubber) so that the weight fractions of all of the components of the asphaltic sealant composition, including any and all further ingredients, will total 100%. Consequently, where the inventive asphaltic sealant composition includes one or more ingredients in addition to the polymer, asphalt, and plasticizer components, the value of the sum of the weight percentages “(% Polymer+% Asphalt+% Plasticizer)” used in the formula stated above for determining the EPC value of the inventive asphaltic sealant composition will total less than 100%. See. e.g., Table 1 below for examples of EPC values calculated for specific asphaltic sealant formulations

For the embodiment of the inventive hot-applied asphaltic sealant composition having no inorganic filler therein, although the amount of asphalt in the composition can be as low as 50% by weight, the total percent by weight of the asphalt (i.e., the asphalt base material) in the sealant composition will preferably be not less than 60% by weight and will more preferably be at least 70% by weight of the total weight of the sealant composition. The asphalt base material will typically be present in an amount in the range of from 70% to 90% by weight of the total weight of the sealant composition.

The base asphalt used in the inventive hot-applied asphaltic sealant composition, either with or without the use of a filler material, can generally be any viscosity, penetration, or Performance Graded (PG) asphalt using the Performance Grading AASHTO asphalt specification. Examples of suitable base asphalt materials include, but are not limited to, asphalts graded as PG 64-22, PG 58-28, PG 67-22, PG 52-34, AC-5, AC-10, AC-20, AC-30, 40-60 pen, 60-70 pen, 85-100 pen, or 120-150 pen, or combinations thereof.

When no inorganic fillers are used in the inventive asphaltic sealant composition, although the amount of polymeric material used in the composition can be as low as 4% by weight or less, the total percent by weight of the one or more polymers contained in the composition will preferably be not less than 5%, more preferably not less than 6%, more preferably not less than 7%, more preferably not less than 7.5%, and more preferably from 7.5% to 10% by weight of the total weight of the asphaltic sealant composition.

The one or more polymers used in the inventive hot-applied asphaltic sealant composition, either with or without the use of an inorganic filler material, will preferably be selected from the group consisting of radial styrene-butadiene-styrene block copolymers, linear styrene-butadiene-styrene block copolymers, styrene butadiene copolymers, styrene isoprene copolymers, styrene isoprene styrene block copolymers, ethylene vinyl acetate, ethylene-propylene-diene monomer rubber, polyethylene, polypropylene, terpolymers of ethylene and butyl acrylate comonomer, and other acrylic copolymers and terpolymers. Each of the one or more polymers used in the inventive asphaltic sealant composition, either with or without the use of an inorganic filler material, will more preferably be a radial styrene-butadiene-styrene block copolymer or a linear styrene-butadiene-styrene block copolymer, or combinations thereof, and will most preferably be a radial styrene-butadiene-styrene block copolymer.

Also in the embodiment of the inventive hot-applied asphaltic sealant composition having no inorganic filler material therein, although the amount of plasticizer used in the composition can be as low as 2% by weight or less, the total percent by weight of the one or more plasticizers used in the composition will more preferably be at least 2.5% or at least 3% by weight of the total weight of the asphaltic sealant composition.

Moreover, we have discovered that, in order to maintain or improve the ductility of the inventive hot-applied asphaltic sealant composition, either with or without the use of an inorganic filler material, and to provide a lower viscosity in the desired range, the ratio of the total percent by weight of the one or more plasticizers to the total percent by weight of the one or more polymers used in the composition will preferably be in the range of from 0.4:1 to 0.6:1, will more preferably be in the range of from 0.45:1 to 0.55:1, and will most preferably be about 0.5:1 (i.e. 0.5±5%).

The one or more plasticizers used in the inventive hot-applied asphaltic sealant compositions, either with or without the use of inorganic filler materials, will preferably have or provide: (i) a molecular weight of less than 1000 g/mole and more preferably less than 500 g/mole; (ii) a boiling point at atmospheric pressure of greater than 250° C. and more preferably greater than 300° C.; (iii) a vapor pressure at 25° C. of less than 1 mmHg and more preferably less than 0.1 mmHg; (iv) chemical compatibility with the primary base resin (i.e. the plasticizer will preferably be fully miscible in the base resin and form a stable, homogeneous solution when added to the base resin); and (v) chemical compatibility with the polymer modifier(s) (i.e. the polymer(s) will preferably swell when placed in a volume of the plasticizer).

The one or more plasticizers used in forming the inventive hot-applied asphaltic sealant composition, either with or without the use of an inorganic filler material, can comprise one or more epoxidized esters of vegetable oils (also referred to as functionalized esters derived from vegetable oil fatty acids). Examples of epoxidized esters of vegetable oils suitable for use in forming the asphaltic sealant include, but are not limited to, epoxidized esters of soybean oil, corn oil, tall oil, and sunflower oil. The epoxidized ester of vegetable oil will preferably be an epoxidized ester of soybean oil and will most preferably be an epoxy functionalized methyl ester of soybean oil. Examples of other epoxidized esters of soybean oil suitable for use in the present invention include, but are not limited to, benzyl, propyl, and ethyl esters of soybean oil.

Examples of other plasticizers suitable for use in the inventive asphaltic sealant composition, either with or without the use of an inorganic filler material, include, but are not limited to esters derived from vegetable oil fatty acids, esters and diesters derived from the esterification of fatty alcohols and carboxylic acids, or from the esterification of alcohols with fatty acids, hydrogenated and non-hydrogenated aromatic oils and related petroleum distillates, hydrogenated and non-hydrogenated naphthenic oils and related petroleum distillates, and paraffinic oils and distillates.

The one or more plasticizers used in the inventive asphaltic sealant composition, either with or without the use of an inorganic filler, will most preferably be a functionalized ester derived from vegetable oil fatty acids, including especially epoxidized methyl esters of soybean oil.

For the embodiment of the hot-applied asphaltic sealant composition which includes an inorganic filler material, we have made two additional ground-breaking discoveries. The first of our additional discoveries is that the primary benefit of inorganic filler addition on sealant performance will be obtained when the inorganic filler material is used to increase the effective polymer concentration (EPC) of the asphaltic sealant composition by reducing the amount of asphalt, on a weight percentage basis, in the formulation. In other words, important sealant properties like viscosity and softening point are dependent on the amount of polymer in the sealant composition on a weight percentage basis of the solubilizing asphalt and plasticizer components. By displacing asphalt with inorganic filler, a higher EPC is provided in accordance with the inventive EPC formula which we have discovered.

The second of our additional ground-breaking discoveries is that the presence of inorganic filler is not detrimental or problematic in regard to the tensile properties of the asphaltic sealant composition so long as the inorganic filler material is strictly limited to titanium dioxide and/or ferric oxide. In other words, any alternative inorganic filler materials such as talc, calcium carbonate, fly ash, silica, alumina-based inorganic materials, etc. will preferably be entirely excluded from the asphaltic sealant composition.

Specifically, we have made the surprising and unexpected discovery that other inorganic fillers reduce the tensile elongation or ductility of hot-applied asphaltic sealant compositions whereas titanium dioxide and ferric oxide do not. Without being bound by any theory, it is believed that the addition of an inorganic filler other than titanium dioxide and/or ferric oxide introduces defects at the interface between the asphalt resin and the surfaces of the inorganic filler particles, which result in reduced tensile properties, namely reduced tensile strength and elongation (ductility). The lack of adequate interfacial adhesion between the surface of the inorganic filler particles and the asphalt is believed to create numerous “micro-cracks” that reduce tensile strength and elongation, especially at low temperatures.

Titanium dioxide (TiO₂) and/or ferric oxide, most preferably titanium dioxide, provide the ability to maintain or improve the tensile properties of the asphaltic sealant composition at low temperatures. Unlike other inorganic fillers, it is believed that the surface treatments or coatings used on commercially available TiO₂ or ferric oxide particles, along with their very small average particle size (preferably less than 500 nanometers and more preferably 300-500 nanometers), reduces the number and severity of defects at the particle-asphalt interface.

All other inorganic fillers, whether coated or non-coated, tend to reduce the tensile properties of the sealant at relatively low temperatures. Moreover, even when other inorganic fillers are merely used in combination with titanium dioxide or ferric oxide, the tensile properties of the asphaltic sealant composition are negatively impacted by the other inorganic fillers. It is believed that this is further evidence that the non-TiO₂ and non-ferric oxide fillers are introducing interfacial adhesion defects between the other inorganic fillers and the asphalt resin materials.

In the embodiment of the inventive hot-applied asphaltic sealant composition which includes a titanium dioxide filler, a ferric oxide filler, or a combination thereof, the titanium dioxide and/or ferric oxide filler material will preferably be present in a total amount of not less than 10% by weight of the total weight of the sealant composition. The titanium dioxide and/or ferric oxide filler material will more preferably be present in a total amount of not less than 12% by weight or not less than 14% by weight of the total weight of the asphaltic sealant composition and will more preferably be present in a total amount in the range of from 14% to 26% by weight of the total weight of the asphaltic sealant composition.

The titanium dioxide filler used in the inventive asphaltic sealant composition will preferably be typical rutile TiO₂ having an alumina or silica coating for improved dispersibility and oil absorption. Rutile titanium dioxide particles of the type treated with an organic coating to further promote dispersion in oil-based media are also preferred.

The ferric oxide filler used in the inventive asphaltic sealant composition will preferably be a particulate ferric oxide having a fine particle size of 5 microns or less, and more preferably 1 micron or less, which is well suited for effective dispersion and pigmenting effect.

Examples of base asphalt materials suitable for use in each embodiment of the inventive hot-applied asphaltic sealant composition have been provided above. For the embodiment of the inventive hot-applied asphaltic sealant composition which includes a titanium oxide and/or ferric oxide filler material, although the amount of asphalt in the composition can be as low as 50% by weight, the total percent by weight of the asphalt (i.e., the asphalt base material) in the sealant composition will preferably be not less than 55% by weight and will more preferably be at least 60% by weight of the total weight of the sealant composition. When the titanium dioxide and/or ferric oxide filler is used, the asphalt base material will typically be present in an amount in the range of from 62% to 76% by weight of the total weight of the asphaltic sealant composition.

Examples of polymers suitable for use in each embodiment of the inventive hot-applied asphaltic sealant composition have also been provided above. When a titanium dioxide and/or ferric oxide filler material is used in the inventive asphaltic sealant composition, although the amount of polymeric material used in the composition can be as low as 4% by weight or less, the total percent by weight of the one or more polymers contained in the composition will preferably be not less than 5%, and will more preferably be in the range of from 5% to 8% by weight of the total weight of the asphaltic sealant composition.

Examples of plasticizers suitable for use in each embodiment of the inventive hot-applied asphaltic sealant composition have additionally been provided above. In the embodiment of the inventive hot-applied asphaltic sealant composition which includes a titanium dioxide and/or ferric oxide filler material, although the total amount of the one or more plasticizers used in the composition can be as low as 2% by weight or less, we have discovered, as also mentioned above, that in order to maintain or improve the ductility of the inventive hot-applied asphaltic sealant composition, and to provide a lower viscosity in the desired range, the ratio of the total percent by weight of the one or more plasticizers to the total percent by weight of the one or more polymers used in the asphaltic sealant composition will preferably be in the range of from 0.4:1 to 0.6:1, will more preferably be in the range of from 0.45:1 to 0.55:1, and will most preferably be about 0.5:1 (i.e. 0.5±5%).

The inventive hot-applied asphaltic sealant composition, either with or without the use of an inorganic filler material, will preferably include an amount of the crumb rubber modifier in the range of from 2% to 12% by weight, more preferably from 3% to 10% by weight, of the total weight of the asphaltic sealant composition. The particle size of the crumb rubber material will preferably be less than 600 micron and more preferably less than 500 micron.

The hot-applied non-asphaltic sealant composition provided by the present invention preferably comprises: a total percent by weight of a base non-asphaltic sealant resin material (% Resin) which is not less than 50% by weight of the total weight of the non-asphaltic sealant composition; a total percent by weight of one or more plasticizers (% Plasticizer) which is not less than 1% by weight of the total weight of the non-asphaltic sealant composition; a total percent by weight of one or more polymers (% Polymer) which is not less than 5% by weight of the total weight of the non-asphaltic sealant composition; and an optional amount of a crumb rubber modifier in the range of from 0% to 15% by weight based upon the total weight of the non-asphaltic sealant composition.

In order to provide significant improvements in the softening point and resilience of the inventive hot-applied non-asphaltic sealant composition while also substantially maintaining or improving the ductility of the composition, we have discovered that the non-asphaltic sealant composition will preferably be formulated to provide an “effective polymer concentration” (EPC) value of not less than 11.2.

For a hot-applied non-asphaltic sealant composition, the EPC parameter which we have discovered is defined as:

EPC=(% Polymer+(% Polymer+% Resin+% Plasticizer))×100

As noted above, and as defined and used herein and in the claims, the % Polymer, % Resin, and % Plasticizer values used in the formula for determining the EPC value of the inventive non-asphaltic sealant composition are the respective individual percent by weight fractions, based upon the total weight of the non-asphaltic sealant composition, of only (1) the total weight of the polymer component(s), (2) the total weight of the resin component(s), and (3) the total weight of the plasticizer component(s) used in the sealant formulation. In addition to these components, the non-asphaltic sealant composition may also include further ingredients (e.g., an inorganic filler and/or crumb rubber) so that the individual weight fractions of all of the components of the non-asphaltic sealant composition, including any and all further ingredients, will total 100%. Consequently, where the inventive non-asphaltic sealant composition includes one or more ingredients in addition to the polymer, resin, and plasticizer components, the value of the sum of the weight percentages “(% Polymer+% Resin+% Plasticizer)” used in the formula stated above for determining the EPC value of the inventive non-asphaltic sealant composition will total less than 100%. Sec. e.g., Table 5 below for examples of EPC values calculated for specific non-asphaltic sealant formulations.

The inventive hot-applied non-asphaltic sealant composition will more preferably have an EPC value of not less than 11.3, or not less than 11.4, or not less than 11.5, or not less than 11.6, or not less than 11.7, or not less than 11.8, or not less than 11.9, or not less than 12.0. The hot-applied non-asphaltic sealant composition will more preferably have an EPC value in the range of from about 12.0 to about 13.0 (i.e., from 12.0 minus 5% up to 13.0 plus 5%).

The EPC value of the non-asphaltic sealant composition can be beneficially increased by (a) increasing the polymer concentration of the composition (% Polymer) and/or (b) adding inorganic filler material to the composition to reduce the amount of non-asphaltic sealant resin material (% Resin).

Unlike the inventive asphaltic sealant compositions discussed above, the particular inorganic filler material selected for use in the inventive hot-applied non-asphaltic sealant composition will typically not have a negative affect on the tensile properties of the non-asphaltic sealant. Consequently, examples of inorganic filler materials suitable for use in the inventive non-asphaltic sealant composition include, but are not limited to, titanium dioxide, ferric oxide, talc, calcium carbonate, fly ash, silica, alumina-based inorganic materials, and combinations thereof.

The one or more inorganic tillers used in the inventive hot-applied non-asphaltic sealant composition will preferably be present in a total amount of not less than 3% by weight of the total weight of the non-asphaltic composition. The one or more inorganic tillers will more preferably be present in a total amount of not less than 4% by weight, or not less than 5%, or not less than 6% by weight of the total weight of the non-asphaltic sealant composition and will more preferably be present in a total amount in the range of from 6.5% to 24% by weight of the total weight of the non-asphaltic sealant composition.

Although the amount of the non-asphalt base resin used in the inventive non-asphaltic sealant composition can be as low as 50% by weight, the total percent by weight of the non-asphalt base resin will preferably be not less than 55% by weight and will more preferably be at least 60% by weight of the total weight of the non-asphaltic sealant composition. The non-asphalt base resin material will typically be present in an amount in the range of from 60% to 80% by weight of the total weight of the sealant composition.

By way of example, but not by way of limitation, the non-asphalt base resin material used in the inventive non-asphaltic sealant composition can comprise or consist of one or more rosin esters comprising amorphous, esterified mixtures of low molecular weight compounds produced from the pulping or processing of wood. The rosin ester material used in the inventive non-asphaltic sealant composition can comprise a single rosin ester or a combination of two or more rosin esters. Rosin ester materials will typically have softening points of greater than 50° C. and needle penetration values of near 0 dmm at 25° C. The rosin ester material(s) used in the inventive non-asphaltic sealant composition will preferably have (a) a softening point in the range of from about 80° C. to about 120° C., more preferably from about 95° C. to about 110° C., and (b) an acid number of less than 20 mg/g and more preferably less than 15 mg/g.

Examples of such rosin ester materials suitable for use in the inventive non-asphaltic sealant composition include, but are not limited to, pine-based pentaerythritol ester resins and pine-based glycerol ester resins. The rosin ester material will preferably be or comprise a pine-based pentaerythritol ester resin. An example of a commercially available pine-based pentaerythritol ester resin is WESTREZ Rosin Ester 5101 produced by Ingevity of Charleston, S.C.

Most preferably, due to the stiff and brittle nature of these materials, rosin esters produced from wood, as well as some other types of non-asphaltic base resins used in the inventive hot-applied non-asphaltic sealant composition, will be blended with an aromatic, naphthenic, paraffinic, and/or vegetable oil processing oil. As used herein and in the claims, unless otherwise stated, all references to the total percent by weight of a non-asphalt sealant resin (% Resin) used in the inventive non-asphaltic sealant composition refer to and include the total weight of both the rosin ester or other non-asphalt resin material used in the inventive composition and the aromatic, naphthenic, paraffinic, and/or vegetable oil processing oil which is blended with the rosin ester or other non-asphalt resin material. The weight ratio of the rosin ester to processing oil used in the rosin/processing oil blend will typically be in the range of from 1.5:1 to 2.5:1 and will preferably about 2:1 (i.e., 2±10%).

As will be understood by those in the art, processing oils are commonly used for blending with rubber and elastomer materials in various processes and applications. The processing oil used in forming the non-asphaltic sealant resin base blend of the inventive composition will preferably comprise one or more aromatic, naphthenic, paraffinic, and/or vegetable oils. The processing oil will preferably (a) be effective for blending with the rosin ester or other resin material to produce a softening point of the base blend in the range of from about 40′ to about 70° C. and a needle penetration value of the base blend in the range of from about 20 to about 80 dmm at 25° C. and (b) have an aromatic content of at least 40% by weight, or at least 45%, 50%, 55%, 60%, 65% or 70% by weight, based upon the total weight of the processing oil. Examples of a commercially available processing oils which are well suited for blending with pine-based pentaerythritol resins and other rosin materials are SUNDEX 165 (an aromatic processing oil having a molecular weight of 588 and an aromatic content of 55% by weight based upon the total weight of the SUNDEX 165) and HYDROLENE LPH. SUNDEX 165 and HYDROLENE LPH are available from HollyFrontier Lubricants and Specialty Products of Tulsa, Okla.

Examples of other types of non-asphalt sealant base resins suitable for use in the inventive hot-applied non-asphaltic sealant composition include, but are not limited to: polyurethane resins such as those derived from the reaction of one or more isocyanate compounds with a flexible chain extender, preferentially a polyether-ester or polyether-amide; epoxy resins such as epoxy resins based on the diglycidyl ether of Bisphenol-A (DGEBA) and DGEBA that is modified with flexible diamines or flexible diols to improve impact toughness; hydrocarbon resins such as C₅ aliphatic. C₉ aromatic, and resins based on Dicyclopentadiene, i.e. DCPD cycloaliphatic resins; and resins formed from paraffinic waxes and oxidized paraffinic waxes.

Although the total amount of the one or more polymers used in the inventive hot-applied non-asphaltic composition can be as low as 5% by weight or less, the total percent by weight of the one or more polymers contained in the composition will preferably be not less than 6%, more preferably not less than 7%, more preferably not less than 8%, more preferably not less than 9%, and more preferably from 9% to 13% by weight of the total weight of the non-asphaltic sealant composition.

Examples of elastomeric polymer materials suitable for use in the inventive non-asphaltic sealant composition include, but are not limited to: styrene block polymers such as radial and/or linear styrene butadiene styrene (SBS) block copolymers, styrene butadiene copolymers, styrene isoprene copolymers, and styrene isoprene styrene (SIS) block copolymers; ethylene vinyl acetate (EVA); polymers such as ethylene-propylene-diene monomer rubber (EPDM) formed by the copolymerization of ethylene and propylene with suitable monomers to disrupt crystallinity; acrylic copolymers and terpolymers such as butyl acrylate and glycidyl methacrylate, which are derived from copolymerization of ethylene with acrylic monomers; and combinations thereof. The one or more elastomeric polymer materials will preferably comprise an SBS polymer and/or an SIS polymer and will more preferably comprise a radial SBS polymer.

Although the total amount of the plasticizers used in the hot-applied non-asphaltic sealant composition can be as low as 0.5% by weight or less, the total percent by weight of the one or more plasticizers used in the non-asphaltic composition will more preferably be at least 1.0% or at least 1.5% by weight of the total weight of the non-asphaltic sealant composition.

The one or more plasticizing materials used in forming the inventive hot-applied non-asphaltic sealant composition can comprise one or more epoxidized esters of vegetable oils (also referred to as functionalized esters derived from vegetable oil fatty acids). Examples of epoxidized esters of vegetable oils suitable for use in forming the non-asphaltic sealant include, but are not limited to, epoxidized esters of soybean oil, corn oil, tall oil, and sunflower oil. The epoxidized ester of vegetable oil will preferably be an epoxidized ester of soybean oil and will most preferably be an epoxy functionalized methyl ester of soybean oil. Examples of other epoxidized esters of soybean oil suitable for use in the present invention include, but are not limited to, benzyl, propyl, and ethyl esters of soybean oil.

Examples of other types of plasticizers suitable for use in the inventive hot-applied non-asphaltic sealant composition include, but are not limited to, esters derived from vegetable oil fatty acids, esters and diesters derived from the esterification of fatty alcohols and carboxylic acids, or from the esterification of alcohols with fatty acids, hydrogenated and non-hydrogenated aromatic oils and related petroleum distillates, hydrogenated and non-hydrogenated naphthenic oils and related petroleum distillates, and paraffinic oils and distillates.

The one or more plasticizers used in the inventive non-asphaltic sealant composition, will most preferably be epoxidized esters of soybean oil.

Once prepared, the asphaltic and non-asphaltic sealant compositions provided by the present invention can be applied to a concrete or asphalt substrate surface to seal cracks and joints using generally any of the hot-application procedures and equipment used for applying asphalt-based sealants.

The following examples are provided for purposes of illustration and are not intended to limit the invention in any way.

### Example 1

Twelve hot-applied asphaltic sealant compositions were prepared as identified in Table 1 with all component amounts listed in Table 1 being expressed as percentages by weight based upon the total weight of the entire composition.

TABLE 1
Hot-Applied Asphaltic Sealant Compositions

| | | Non- | | | | | |
|---|---|---|---|---|---|---|---|
| | TiO₂ | TiO₂ | | | Crumb | | |
| Example | Filler | Filler | Polymer | Plasticizer | Rubber | Asphalt | EPC |
| 23 | 22 | 0 | 6 | 3 | 5 | 64 | 8.23 |
| 123 | 0 | 22 | 6 | 3 | 4.5 | 64.5 | 8.16 |
| 147 | 0 | 22 | 6 | 3 | 4.5 | 64.5 | 8.16 |
| 162 | 10 | 10 | 6 | 3 | 4 | 67 | 7.89 |
| 163 | 10 | 10 | 6 | 3 | 4 | 67 | 7.89 |
| 168 | 0 | 20 | 6 | 3 | 4 | 67 | 7.89 |
| 175 | 20 | 0 | 6 | 3 | 4 | 67 | 7.89 |
| 176 | 0 | 20 | 6 | 3 | 4 | 67 | 7.89 |
| 181 | 0 | 20 | 6 | 3 | 4 | 67 | 7.89 |
| 170 | 0 | 0 | 6 | 3 | 4 | 87 | 6.3 |
| 159 | 10 | 0 | 6 | 3 | 4 | 77 | 7.0 |
| 160 | 16 | 0 | 6 | 3 | 4 | 71 | 7.5 |

The polymers used in the asphaltic sealant compositions of Table 1 were SBS block copolymers of both radial and linear architectures. The plasticizer used in the compositions of Table 1 was an epoxidized methyl ester of soybean oil. The non-TiO₂ filler used in examples 123 and 162 was calcium carbonate. The non-TiO₂ filler used in examples 147 and 163 was talc. The non-TiO₂ filler used in example 176 was calcium carbonate with ultratine particle size distribution. The non-TiO₂ filler used in example 181 was fly ash with ultratine particle size distribution.

The performance properties measured for the hot-applied asphaltic sealant compositions of Table 1 are provided in Table 2.

TABLE 2
Performance Properties of the Compositions of Table 1

| | 350° | | | 4° |
|---|---|---|---|---|
| | Rotational | Softening | Resilience | Ductility |
| Example | Viscosity | Point (° C.) | (%) | (cm) |
| 23 | 4075 | 99 | 61 | 20 |
| 123 | 4488 | 99.5 | 62 | 4.5 |
| 147 | 7750 | 107 | 60 | 8 |
| 162 | 3263 | 96 | 56 | 5 |
| 163 | 3413 | 96 | 58 | 5.5 |
| 168 | 2775 | 99.5 | 59 | 7 |
| 175 | 2725 | 94 | 64 | 19.5 |
| 176 | 3525 | 97 | 59 | 2.5 |
| 181 | 3138 | 94 | 63 | 5.5 |
| 170 | 1025 | 90.5 | 59 | 26.5 |
| 159 | 1713 | 97 | 65 | 11 |
| 160 | 2588 | 97 | 63 | 30 |

As seen in Tables 1 and 2, none of the asphaltic sealant compositions which contained non-titanium dioxide fillers had 4° C. ductilities in the range of 20 cm. All of the formulations that contained other types of inorganic tillers, whether alone or in addition to TiO₂, had deficient tensile properties, i.e., 4° C. ductilities of less than 10 cm, and in some cases 5 cm or less. Even in those examples where a portion of the non-TiO₂ filler was replaced with TiO₂ (see examples 162 and 163), the tensile properties were negatively impacted. As noted above, we believe this was evidence that the non-TiO₂ fillers introduced interfacial adhesion defects between the inorganic filler and the asphalt base resin.

However, when a titanium dioxide filler was used, without the presence of any non-TiO₂ filler material, to reduce the amount of the base asphalt resin and effectively increase the effective polymer concentration (EPC) of the asphaltic sealant composition, the softening point and resilience of the composition were improved with the 4° C. ductility of the composition being maintained at around 20 cm or even improved, particularly when the amount of titanium dioxide filler in the composition was greater than 10% by weight. This was seen in examples 170, 159, 160, 175, and 23 as an increasing amount of titanium dioxide filler continuously reduced the amount of the base asphalt resin and increased the EPC of the composition.

### Example 2

Four hot-applied asphaltic sealant compositions were prepared as identified in Table 3 with all component amounts listed in Table 3 being expressed as percentages by weight based upon the total weight of the entire composition. These asphaltic sealant compositions contained no inorganic filler materials.

TABLE 3
Hot-Applied Asphaltic Sealant Compositions with No Filler

| | Ti0₂ | | | Effective | | Crumb |
|---|---|---|---|---|---|---|
| Example | Filler | Polymer | Asphalt | Polymer | Plasticizer | Rubber |
| 170 | 0 | 6 | 87 | 6.3 | 3 | 4 |
| 174 | 0 | 8 | 84.5 | 8.4 | 3 | 4.5 |
| 177 | 0 | 8 | 81 | 8.7 | 3 | 8 |
| 180 | 0 | 8 | 82 | 8.5 | 4 | 6 |

The polymers used in the asphaltic sealant compositions of Table 3 were SBS block copolymers of both radial and linear architectures. The plasticizer used in the compositions of Table 3 was an epoxidized methyl ester of soybean oil.

The performance properties measured for the hot-applied asphaltic sealant compositions of Table 3 are provided in Table 4.

TABLE 4
Performance Properties of the Compositions of Table 3

| | 350° | | | |
|---|---|---|---|---|
| | Rotational | | | 4° C. |
| | Viscosity | Softening | Resilience | Ductility |
| Example | (cp) | Point (° C.) | (%) | (cm) |
| 170 | 1025 | 90.5 | 59 | 26.5 |
| 174 | 1900 | 103.5 | 68 | 32 |
| 177 | 3938 | 109.5 | 75 | 21 |
| 180 | 2463 | 101.5 | 78 | 41.5 |

When the effective polymer concentration (EPC) value was around 6 as in example 170, the viscosity of the asphaltic sealant composition was very low, but the softening point and resilience also fell below the most preferable ranges. When the EPC value was increased to 8 or higher as in examples 174, 177, and 180, without the use of filler, the viscosity increased and the softening point and resilience moved into the most preferred range. In addition, the tensile properties, i.e., the 4° C. ductilities, of examples 174, 177, and 180 were all in the more preferred or most preferred range.

Example 177 indicated that when the EPC exceed a value of 8 and the plasticizer level was only 3% by weight, the viscosity exceeded the preferred range at 350° F. and the tensile strength became so high that the ductility was below the most preferred range. However, when the plasticizer level was increased to 4% by weight in example 180 such that it is about one half of the concentration of the polymer material, all of the sealant performance properties (i.e., rotational viscosity, softening point, resilience, and ductility) fell in the most preferred ranges.

### Example 3

Four hot-applied non-asphaltic sealant compositions were prepared as identified in Table 5 with all component amounts listed in Table 5 being expressed as percentages by weight based upon the total weight of the entire composition.

TABLE 5
Hot-Applied Non-Asphaltic Sealant Compositions

| | | Non | | Resin | | | |
|---|---|---|---|---|---|---|---|
| Exam- | TiO₂ | TiO₂ | | (non- | Effective | Plasti- | Crumb |
| ple | Filler | Filler | Polymer | asphalt) | Polymer | cizer | Rubber |
| 66 | 10.7 | 9.6 | 10 | 67.7 | 12.5 | 2 | 0 |
| 10 | 5.7 | 14.6 | 10 | 67.7 | 12.5 | 2 | 0 |
| 11 | 7 | 0.5 | 10 | 80.5 | 10.8 | 2 | 0 |
| 12 | 8 | 0.5 | 11.5 | 77.5 | 12.6 | 2.5 | 0 |

The non-asphalt base resin material used in examples 66, 10, 11, and 12 was a blend of a rosin ester (i.e., WESTREZ 5101) and a naphthenic processing oil (i.e., HYDROLENE LPH) the weight ratio of the rosin ester to the naphthenic processing oil in the non-asphalt base resin blend was 1.9 to 1.

The polymers used in the non-asphaltic sealant compositions of Table 5 were radial SBS block copolymers. The plasticizer used in each of the compositions of Table 5 was an epoxidized methyl ester of soybean oil. The non-TiO₂ filler used in examples 66, 10, 11, and 12 was calcium carbonate.

The performance properties measured for the hot-applied non-asphaltic sealant compositions of Table 5 are provided in Table 6.

TABLE 6
Performance Properties of Compositions of Table 5

| | 350° F. | | | |
|---|---|---|---|---|
| | Rotational | | | 4° C. |
| | Viscosity | Softening | Resilience | Ductility |
| Example | (cp) | Point (° C.) | (%) | (cm) |
| 66 | 6363 | 85 | 55 | 29.5 |
| 10 | 6813 | 85 | 67 | 38 |
| 11 | 3175 | 80 | 40 | 36 |
| 12 | 5200 | 83.5 | 59 | 44 |

By reference to the non-asphalt sealant formulations in Table 5 and the corresponding properties in Table 6, it is seen that the non-asphalt resin compositions did not suffer from a loss of 4° C. ductility when non-TiO₂ fillers were used, as was the case with the asphalt-based sealant examples.

When the inorganic filler content of the non-asphaltic sealant compositions was reduced without a corresponding increase in the polymer content as with example 11, the overall performance properties of the sealant composition were negatively impacted. This was a result of a drop in the effective polymer concentration (EPC) value of the non-asphaltic composition.

However, when the filler content was reduced but the polymer content was increased to keep the EPC value constant as with example 12, the performance properties of the non-asphaltic sealant composition fell in the preferred ranges.

Thus, the present invention is well adapted to carry out the objects and attain the ends and advantages mentioned above as well as those inherent therein. While presently preferred embodiments have been described for purposes of this disclosure, numerous changes and modifications will be apparent to those in the art. Such changes and modifications are encompassed within this invention as defined by the claims.

What is claimed is:

1. An asphaltic sealant composition which uses an effective polymer concentration (EPC) to improve a softening point and a resilience of the asphaltic sealant composition while at least reducing or preventing a loss of or providing an increase in ductility, the asphaltic sealant composition comprising:
a total percent by weight of asphalt (% Asphalt) which is not less than 50% by weight of a total weight of the asphaltic sealant composition;
a total percent by weight of one or more plasticizers (% Plasticizer) which is not less than 2% by weight of the total weight of the asphaltic sealant composition;
a total percent by weight of one or more polymers (% Polymer) which is not less than 4% by weight of the total weight of the asphaltic sealant composition, each of the one or more polymers being selected from the group consisting of radial styrene-butadiene-styrene block copolymers, linear styrene-butadiene-styrene block copolymers, styrene butadiene copolymers, styrene isoprene copolymers, styrene isoprene styrene block copolymers, ethylene vinyl acetate, ethylene-propylene-diene monomer rubber, polyethylene, polypropylene, terpolymers of ethylene and butyl acrylate comonomer, other acrylic copolymers, and other acrylic terpolymers;
a crumb rubber modifier in an amount in a range of from 0% to 15% by weight based upon the total weight of the asphaltic sealant composition;
the asphaltic sealant composition having no inorganic filler material therein, or the asphaltic sealant composition having one or more inorganic fillers limited to only titanium dioxide and/or ferric oxide so that the asphaltic sealant composition excludes any inorganic filler other than titanium dioxide and/or ferric oxide; and
the EPC of the asphaltic sealant composition, defined as
EPC=(% Polymer+(% Polymer+% Asphalt+% Plasticizer))×100,
being not less than 7.0.

2. The asphaltic sealant composition of claim 1 further comprising:
the asphaltic sealant composition including the one or more inorganic fillers limited to only titanium dioxide and/or ferric oxide and
the titanium dioxide and/or the ferric oxide being present in a total amount of not less than 10% by weight of the total weight of the asphaltic sealant composition.

3. The asphaltic sealant composition of claim 2 further comprising each of the one or more plasticizers being an epoxidized ester of a vegetable oil.

4. The asphaltic sealant composition of claim 3 further comprising:
each of the one or more polymers being a radial styrene-butadiene-styrene block copolymer or a linear styrene-butadiene-styrene block copolymer and
each of the one or more plasticizers being an epoxidized methyl ester of soybean oil.

5. The asphaltic sealant composition of claim 2 further comprising:
the total percent by weight of the asphalt being not less than 55% by weight of the total weight of the asphaltic sealant composition;
the total percent by weight of the one or more polymers being not less than 5% by weight of the total weight of the asphaltic sealant composition;
the total amount of the titanium dioxide and/or ferric oxide being not less than 12% by weight of the total weight of the asphaltic sealant composition; and
the EPC of the asphaltic sealant composition being not less than 7.2.

6. The asphaltic sealant composition of claim 5 further comprising the amount of the crumb rubber modifier being from 3% to 10% by weight of the total weight of the asphaltic sealant composition.

7. The asphaltic sealant composition of claim 2 further comprising the one or more inorganic fillers being only a single inorganic filler which is titanium dioxide.

8. The asphaltic sealant composition of claim 2 further comprising a ratio of the total percent by weight of the one or more plasticizers to the total percent by weight of the one or more polymers being in a range of from 0.4:1 to 0.6:1.

9. The asphaltic sealant composition of claim 8 further comprising the ratio of the total percent by weight of the one or more plasticizers to the total percent by weight of the one or more polymers being in a range of from 0.45:1 to 0.55:1.

10. The asphaltic sealant composition of claim 1 further comprising:
the asphaltic sealant composition having no inorganic filler material therein and
the total percent by weight of the asphalt being not less than 60% by weight of the total weight of the asphaltic sealant composition.

11. The asphaltic sealant composition of claim 10 further comprising each of the one or more plasticizers being an epoxidized ester of a vegetable oil.

12. The asphaltic sealant composition of claim 11 further comprising:
each of the one or more polymers being a radial styrene-butadiene-styrene block copolymer or a linear styrene-butadiene-styrene block copolymer, and
each of the one or more plasticizers being an epoxidized methyl ester of soybean oil.

13. The asphaltic sealant composition of claim 10 further comprising:
the total percent by weight of the asphalt being not less than 70% by weight of the total weight of the asphaltic sealant composition;
the total percent by weight of the one or more polymers being not less than 6% by weight of the total weight of the asphaltic sealant composition; and
the EPC of the asphaltic sealant composition being not less than 7.5.

14. The asphaltic sealant composition of claim 13 further comprising the amount of the crumb rubber modifier being from 3% to 10% by weight of the total weight of the asphaltic sealant composition.

15. The asphaltic sealant composition of claim 10 further comprising a ratio of the total percent by weight of the one or more plasticizers to the total percent by weight of the one or more polymers being in a range of from 0.4:1 to 0.6:1.

16. The asphaltic sealant composition of claim 15 further comprising the ratio of the total percent by weight of the one or more plasticizers to the total percent by weight of the one or more polymers being in a range of from 0.45:1 to 0.55:1.

17. A non-asphaltic sealant composition which uses an effective polymer concentration (EPC) to improve a softening point and a resilience of the non-asphaltic sealant composition while at least reducing or preventing a loss of or providing an increase in ductility, the non-asphaltic sealant composition comprising:
a total percent by weight of a non-asphalt sealant resin (% Resin) which is not less than 50% by weight of a total weight of the non-asphaltic sealant composition;
a total percent by weight of one or more plasticizers (% Plasticizer) which is not less than 0.5% by weight of the total weight of the non-asphaltic sealant composition;
a total percent by weight of one or more polymers (% Polymer) which is not less than 5% by weight of the total weight of the non-asphaltic sealant composition, each of the one or more polymers being selected from the group consisting of radial styrene-butadiene-styrene block copolymers, linear styrene-butadiene-styrene block copolymers, styrene butadiene copolymers, styrene isoprene copolymers, styrene isoprene styrene block copolymers, ethylene vinyl acetate, ethylene-propylene-diene monomer rubber, polyethylene,
polypropylene, terpolymers of ethylene and butyl acrylate comonomer, other acrylic copolymers, and other acrylic terpolymers;
a crumb rubber modifier in an amount in a range of from 0% to 15% by weight based upon the total weight of the non-asphaltic sealant composition;
one or more inorganic fillers in a total amount of not less than 3% by weight of the total weight of the non-asphaltic sealant composition; and
the EPC of the non-asphaltic sealant composition, defined as
EPC=(% Polymer+(% Polymer+% Resin+% Plasticizer))×100,
being not less than 11.2.

18. The non-asphaltic sealant composition of claim 17 further comprising:
the non-asphalt sealant resin being selected from rosin esters and blends of rosin esters with aromatic and/or naphthenic oils;
each of the one or more inorganic fillers being selected from the group consisting of titanium dioxide, ferric oxide, talc, calcium carbonate, fly ash, silica, and alumina-based inorganic fillers; and
each of the one or more plasticizers being an epoxidized ester of a vegetable oil.

19. The non-asphaltic sealant composition of claim 18 further comprising each of the one or more polymers being a radial styrene-butadiene-styrene block copolymer or a linear styrene-butadiene-styrene block copolymer.

20. The non-asphaltic sealant composition of claim 18 further comprising:
the total percent by weight of the non-asphalt sealant resin being not less than 60% by weight of the total weight of the non-asphaltic sealant composition;
the total percent by weight of the one or more polymers being not less than 8% by weight of the total weight of the non-asphaltic sealant composition; and
the EPC of the non-asphaltic sealant composition being not less than 11.8.
